(19) United States
(12) Patent Application Publication
(10) Pub. No.: US 2006/0044128 A1
(43) Pub. Date: Mar. 2, 2006

(54) Vehicle lighting system

(75) Inventor: Tilo Schweers, Pforzheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/212,766

(22) Filed: Aug. 29, 2005

(30) Foreign Application Priority Data
Aug. 30, 2004 (DE) 102004042108.0

(51) Int. Cl. B60Q 1/50; B60Q 1/44; G08B 21/00

(52) U.S. Cl. 340/464; 340/479; 340/467; 340/641

(57) ABSTRACT

A vehicle lighting system includes rear blinking lights and brake lights, which can be used together for a braking process and/or a blinking process. Control electronics are provided, which drive the rear blinking lights and brake lights, and if one of the rear blinking lights fails, the control electronics change a load resistor in the blinker circuit. In this manner, a blinker controller increases the blinking frequency in order to indicate the defect in the blinking light.

### BACKGROUND AND SUMMARY OF THE INVENTION

This application claims the priority of German patent document 102004042108.0, filed Aug. 30, 2004, the disclosure of which is expressly incorporated by reference herein.

The invention relates to a vehicle lighting system having rear blinking lights and brake lights.

Diffusors for rear blinker lights and brake lights of vehicle lighting systems must satisfy specific minimum parameters to comply with the present-day certification directives for vehicles for the European market. Applicable American and Canadian regulations, however, demand larger diffusor areas. If a vehicle which was originally developed, for example, for the European market is to be retrospectively modified to comply with the American and Canadian directives (FMVSS/CMVSS Directives), costly changes must be made to the rear lighting. In particular, new tools for the diffusors and reflectors in this case incur high costs and long lead times.

It is known from the prior art to make the diffusor for the rear blinkers red in order to satisfy the American and Canadian directives. Red rear blinking lights are permissible in the USA and Canada. The rear blinking lights and brake lights are each driven jointly for blinking and/or braking, so that the legally stipulated size of the diffusor area is provided. The system is generally designed such that blinking on one side has priority over the use of the lights as brake lights. The priority for simultaneous braking and warning blinking may be chosen as required by the vehicle manufacturer on the basis of the present-day legal situation.

However, this circuitry becomes problematic when it is to be retrofitted into a vehicle, since vehicles in Europe and in the USA and/or Canada must indicate that a blinking light has failed by increasing the blinking frequency. The failure identification, which is generally integrated in a blinker controller and is based on monitoring the current flow in a blinker circuit, must not be adversely affected by the adaptation to the vehicle lighting system.

U.S. Pat. No. 5,028,908 discloses control electronics for brake lights and blinking lights in the rear vehicle area.

One object of the present invention is to provide a vehicle lighting system which combines the rear blinking lights and brake lights for blinking and braking processes, and also indicates a failure of a blinking light by a higher blinking frequency.

This and other objects and advantages are achieved by the light system according to the invention, in which control electronics drive rear blinking lights and brake lights, and change a load resistance in the blinker circuit in the event of a failure of one of the rear blinking lights. A blinker controller increases the blinking frequency to indicate the defect in the blinking light.

By the addition of the respective diffusors for the lights, the joint drive for the rear blinking lights and brake lights advantageously provides an embodiment that complies with the law, satisfying the legal size regulations for simultaneous stipulated failure identification of a blinking light, which is simulated by the control electronics according to the invention in the vehicle. Furthermore, the control electronics according to the invention achieve cost savings and can be implemented quickly, particularly in small quantities, since the use of the additional control electronics in the vehicle avoids the need for a new development of the rear light for retrospective certification in the USA and/or Canada.

In one embodiment of the vehicle lighting system according to the invention, the control electronics also indicate a defect in one of the brake lights by emitting appropriate information to a driver.

In a further embodiment of the invention, the control electronics identify a defect in one of the rear blinking lights and/or brake lights by monitoring the current flow in the corresponding lamp current branch.

In yet another embodiment of the vehicle lighting system, the control electronics use a switching contact to connect at least one output of the blinker controller to a ground potential via a first load resistor in order to drive the rear blinking lights during normal operation. The control electronics connect the appropriate output of the blinker controller by means of the switching contact and a second load resistor to the ground potential when a defect is identified in at least one of the rear blinking lights.

The resistance of the second load resistor is greater, for example, than the resistance of the first load resistor. The blinker control circuit thus identifies an increase in the load resistance which represents a blinker light defect, and increases the blinking frequency.

In an alternative advantageous embodiment of the vehicle lighting system, the control electronics connect at least one output of the blinker controller to one of the blinking lights and/or the brake lights via a switching contact in order to drive the rear blinking lights during normal operation. The control electronics open the switching contact when a defect is identified in at least one of the rear blinking lights, and the blinking controller disconnects the blinking light and/or the brake light. This embodiment avoids the need for the additional load resistors, and also reduces power consumption, because there is no need for current to flow through a relatively low load resistance during normal operation.

In a refinement of the alternative embodiment of the invention, when a defect is identified in the light which is connected to the output of the blinker controller via the switching contact, the control electronics keep the switching contact closed, and open the switching contact when a defect is identified in the light that is not connected to the blinker controller, in order to disconnect the blinker controller from the corresponding intact blinking light and/or the intact brake light. In the first situation, the blinker controller identifies the defective light directly, and in the second case, the control electronics simulate the defect of a lamp by opening the switching contact. In both situations, the blinker controller increases the blinking frequency in order to indicate the light defect.

In a further refinement of the vehicle lighting system, once the switching contact has been opened, the control electronics drive the intact blinking and/or brake lights, in order to maintain an emergency mode, with a reduced illuminated area.

The load resistance of the blinker controller is increased, for example, by the defective light directly or by the opening of the switching contact by the control electronics. As a result, the blinker controller identifies a defective light, and increases the blinking frequency.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block diagram of a first representative embodiment of the invention; and

FIG. 2 is a block diagram of a second representative embodiment of a vehicle lighting system according to the invention.

### DETAILED DESCRIPTION OF THE DRAWINGS

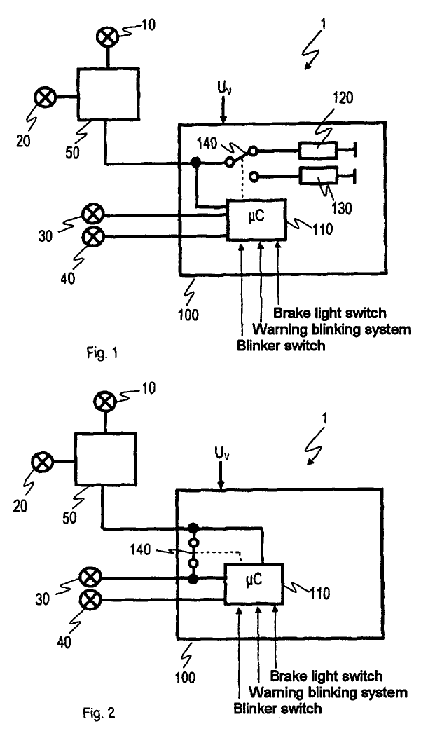

FIG. 1 shows a schematic block diagram of a vehicle lighting system, illustrating only those components of one half of the vehicle that are significant to the invention. As can be seen from FIG. 1, the vehicle lighting system according to the invention has rear blinking lights 30, front blinking lights 10, side blinking lights 20 and brake lights 40, only one of which is in each case illustrated. The rear blinking lights 30 and brake lights 40 can be used in a combined manner for a braking process and/or blinking process. A control electronics unit 100 drives the rear blinking lights 30 and brake lights 40 via an evaluation and control unit 110 which, for example, is in the form of a microprocessor circuit.

In general, in the event of a failure of one of the blinking lights 10, 20, 30 a load resistance in the blinker circuit is changed, preferably by increasing it. The blinker circuit includes the control electronics 100, the rear blinking lights 30, and the blinker controller 50, as well as the front blinking lights 10 and side blinking lights 20. By increasing the load resistance, the blinker controller 50 increases the blinking frequency of the remaining intact blinking lights, thus making it possible to indicate that one of the blinking lights 30 is defective. In the embodiment of FIG. 1, the load resistance in the blinker circuit is changed by the control electronics 100 in the event of a failure of one of the rear blinking lights 30, such that the blinker controller increases the blinking frequency, and indicates that one of the rear blinking lights 30 is defective.

As is also evident from FIG. 1, the blinker controller 50 is connected directly to the control electronics 100, but not to the rear blinking lights 30. One of the outputs of the blinker controller 50 is connected to ground via a first load resistor 120 and an electrical switching contact 140. The value of this load resistor 120 is defined such that the current flow of the output of the standard blinker controller 50 or blinking relay corresponds to the current flow through an intact blinking light.

During a blinking process, the control electronics 100 drive the rear blinker light 30 and the brake light 40 on one vehicle side in a combined manner, corresponding to the blinking pulse on the right and/or left. In this case, the control electronics 100 monitor the current flow through the two lights 30, 40. If a failure of one or both lights is detected (based on the same criteria as in the original blinker controller in the production vehicle), then the control electronics 100 switch over via the switching contact 140 to the higher load resistance 130, so that the appropriate output of the blinker controller 50 is connected to the higher load resistance 130. This reduces the current through the standard blinker controller 50, so that a failure of a blinking light 30 is identified there, and the blinking frequency is increased.

During a braking process, the combined rear lights 30, 40 on one vehicle side have currents applied to them jointly and permanently both on the right and on the left. If the turn indicator is operated while braking, then the blinking process has priority on the relevant vehicle side. On the other vehicle side, in contrast, the combined brake/blinking lights are still permanently illuminated, as long as the brake pedal is operated. The appropriate activation signals for carrying out a blinking process or a braking process are applied to the evaluation and control unit 110 for the control electronics, as illustrated in FIG. 1. By way of example, the activation signals originate from a brake light switch and/or from a warning blinking system, and/or from a blinker switch.

The rear lights 30, 40 can also be monitored during a braking process. The information about a defective light is then emitted to the driver by means of information which is independent of the blinking system, for example by appropriate visible or audible output from a driver information system (not illustrated).

The described system complies with all the legal requirements in terms of the size of the diffusors of the rear blinking lights and brake lights, and the indication of a defective blinking light.

FIG. 2 is a schematic block diagram of a further exemplary embodiment of the vehicle lighting system according to the invention, in which identical components or elements which operate in an analogous manner are identified by the same reference symbols as in FIG. 1. In contrast to the embodiment in FIG. 1, the control electronics 100 in FIG. 2 have only the evaluation and control unit 110 and a switching contact 140. In this arrangement, the output of the blinker control circuit 50 is connected to one of the two rear lights 30, 40 during normal operation via the switching contact 140 of the control electronics 100. This connection results in a normal operating current flow at the output of the blinker control circuit 50. If the control electronics 100 detect a defect in at least one of the rear blinking lights 30 or brake lights, then the evaluation and control unit 110 opens the switching contact 140, disconnecting the blinker controller 50 from the blinking light 30 and/or the brake light 40. This change increases the load resistance, which reduces the current flow at the output of the blinker control circuit. The blinker controller detects a defective blinking light in a manner corresponding to that in a production vehicle, and indicates it by a higher blinking frequency.

In an alternative embodiment, the evaluation and control unit 110 as shown in FIG. 2 keeps the switching contact 140 closed when a defect is identified in the light 30 (which therefore remains connected via the switching contact 140 to the output of the blinker controller 50), and the blinker controller 50 detects the defect directly. If the evaluation and control unit 110 identifies a defect in a light 40 which is not connected to the blinker controller 50, then the evaluation and control circuit 110 opens the switching contact 140, and the blinker controller 50 is disconnected from the intact blinking light 30 and/or the intact brake light 40, and the current at the output of the blinker controller 50 is reduced. The blinker controller 50 thus identifies the defect in a blinking light, and indicates the defect by increasing the blinking frequency.

In the embodiment shown in FIG. 2, the additional load resistors 120, 130 are omitted. Furthermore, the power consumption is reduced since there is no need for current to flow through a relatively low load resistance 120 during normal operation without any defective blinking lights.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle lighting system having rear blinking lights and brake lights which can be used in a combined manner for a braking process and/or a blinking process, said lighting system comprising:
control electronics; and
a blinker controller; wherein,
the control electronics drive the rear blinking lights and brake lights; and
if one of the rear blinking lights fails, the control electronics change a load resistor in a blinker circuit such that the blinker controller indicates the defect in the blinking light by a higher blinking frequency.

2. The vehicle lighting system as claimed in claim 1, wherein the control electronics signal a defect in one of the brake lights as appropriate information to a driver.

3. The vehicle lighting system as claimed in claim 1, wherein the control electronics identify a defect in one of the rear blinking lights and/or brake lights by monitoring the current flow in the appropriate lamp current branch.

4. The vehicle lighting system as claimed in claim 3, wherein:
the control electronics use a switching contact to connect at least one output of the blinker controller to a ground potential via a first load resistor in order to drive the rear blinking lights during normal operation; and
by means of a switching contact the control electronics connect said output of the blinker controller to the ground potential via a second load resistor when a defect is identified in at least one of the rear blinking lights.

5. The vehicle lighting system as claimed in claim 4, wherein resistance of the second load resistor is greater than resistance of the first load resistor.

6. The vehicle lighting system as claimed in claim 4, wherein:
the control electronics connect at least one output of the blinker controller to at least one of the blinking lights and the brake lights via a switching contact in order to drive the rear blinking lights during normal operation; and
when a defect is identified in at least one of the rear blinking lights, the control electronics open the switching contact and the blinking controller disconnects at least one of the blinking light and the brake light.

7. The vehicle lighting system as claimed in claim 4, wherein:
the control electronics connect at least one output of the blinker controller via a switching contact to at least one of the blinking lights and of the brake lights to drive the rear blinking lights during normal operation;
the control electronics keep the switching contact closed when a defect is identified in a light which is connected to the output of the blinker controller via the switching contact; and
the control electronics open the switching contact when a defect is identified in a light which is not connected to the blinker controller, and disconnects the blinker controller from a corresponding intact blinking light or brake light.

8. The vehicle lighting system as claimed in claim 7, wherein the control electronics drive the intact blinking light and/or brake light after the opening of the switching contact.

9. The vehicle lighting system as claimed in claim 8, wherein the load resistance of the blinker controller resulting from the defective light is increased directly or by the opening of the switching contact such that the blinker controller increases the blinking frequency.
